(19) United States
(12) Patent Application Publication
(10) Pub. No.: US 2009/0137163 A1
(43) Pub. Date: May 28, 2009

(54) INFRASTRUCTURE DEVICE WITH MODULAR REPLACEABLE SENSORS

(75) Inventor: Roland Schoettle, American Canyon, CA (US)

Correspondence Address: OPTIMAL TECHNOLOGIES, INC., 1001 West 4th St., Winston-Salem, NC, 27101, US

(73) Assignee: Optimal Innovations Inc., Bridgetown (BB)

(21) Appl. No.: 11/944,989

(22) Filed: Nov. 26, 2007

(51) Int. Cl. H01R 13/73

(52) U.S. Cl. 439/894

(57) ABSTRACT

The present invention is directed to a system and method which allows a user to renew, expand, or reduce a utility device by changing, adding, or subtracting only the module that needs to be renewed, added, or removed as opposed to replacing the entire device. In one embodiment, the device is constructed in modular format such that the user need only replace the module portion of the device that has expired (or been used) instead of being required to replace the entire device.

### CROSS-REFERENCE TO RELATED APPLICATIONS

This application is related to U.S. patent application Ser. No. 11/683,298 filed Mar. 7, 2007 entitled “LIGHT SWITCH USED AS A COMMUNICATION DEVICE”; U.S. patent application Ser. No. 11/683,326 filed Mar. 7, 2007 entitled “ANTICIPATORY UTILITY CONTROL DEVICE”; U.S. patent application Ser. No. 11/683,335 filed Mar. 7, 2007 entitled “PLUG AND PLAY UTILITY CONTROL MODULES”; U.S. Provisional Patent Application No. 60/956,314 filed Aug. 16, 2007 entitled “UTILITY OUTLETS AS A SECURITY SYSTEM”; U.S. Provisional Patent Application No. 60/940,010 filed May 24, 2007 entitled “LIGHT SWITCH AS A WIRELESS HUB”; U.S. Provisional Patent Application No. 60/940,010 filed May 24, 2007 entitled “UTILITY OUTLETS AS REMOTE CONTROL REPEATERS”; U.S. Provisional Patent Application No. 60/956,306 filed Aug. 16, 2007 entitled “USING UTILITY OUTLETS TO DETERMINE AND REPORT MEDIA-BASED ACTIVITY”, U.S. patent application Ser. No. 11/875,712 filed Oct. 19, 2007 entitled “SIZE UNCONSTRAINED FACEPLATE DISPLAY FOR USE WITH INFRASTRUCTURE DEVICE,” U.S. patent application Ser. No. 11/875,726 filed Oct. 19, 2007 entitled “INFRASTRUCTURE DEVICE WITH REMOVABLE FACE PLATE FOR REMOTE OPERATION,” and U.S. patent application Ser. No. (not yet assigned) filed concurrently herewith, Attorney Docket No. 66816-P038US-10715043 entitled “INFRASTRUCTURE DEVICE WITH MODULAR REMOTE SENSORS,” the disclosures of which are incorporated herein by reference.

### TECHNICAL FIELD

This disclosure relates to infrastructure utility devices and more particularly to such devices having modular replaceable sensors.

### BACKGROUND OF THE INVENTION

Utility devices are devices that are mounted to a premises infrastructure, Lights, light switches, electrical power sockets are typical examples of utility devices. One aspect of an infrastructure device is that it is connected, at least electrically, to wiring affixed to the premises structure. Another aspect of an infrastructure device is that it can be connected via wired or wireless communications to devices that are themselves connected electrically to the premises electricity delivery infrastructure. In some situations, a standalone light switch that has a sensor can act to alarm locally (without being part of a bigger grouping) for fire and other environmental parameters. For the purposes of having sensors remote from the device that act as part of it, there must be a method of communicating with the device.

A light switch is one form of an infrastructure device. An electrical outlet is another form of such a device. A TV, radio, security system, surveillance system, premise-based communication system, or game box is yet another form of such device. Other infrastructure devices can be, for example, a wide variety of sensors/systems such as are obvious (e.g., light switches, plugs, thermostats, inline power boxes, etc) but also non-obvious sensors/systems such as light sensors, temperature sensors internet access systems, WAN system, LAN systems, RF systems, display systems, power sensors, power supply systems, schedulers, clocks, audio/video systems, intercom systems, telephone systems, HVAC systems, television, radio, cameras, proximity sensors, occupancy sensors, motion sensors, GPS, entertainment systems, safety monitoring systems, security systems, fire monitoring systems, surveillance systems, messaging systems, alert and alarm systems, medical monitoring systems, data monitoring systems, data control systems, access monitoring systems, access control systems, legacy remote control systems (e.g., TVs, radios, lighting), media reader systems, identification systems, humidity sensors, barometric pressure sensors, weight sensors, traffic pattern sensors, power quality sensors, operating costs, power factor sensors, meters, storage systems, distributed generation systems, UPS systems, battery monitoring systems, priority systems, inertia sensors, glass break sensors, fire sensors, flood sensors, vibration sensors, smoke sensors, carbon dioxide sensors, carbon monoxide sensors, ultrasound sensors, infra-red sensors, microwave sensors, radiation sensors, bacteria sensors, bio-hazard sensors, disease sensors, poison sensors, germ sensors, toxic material sensors, air quality sensors, laser sensors, load sensors, stress sensors, cantilever sensors, material sensors, load control systems, load monitoring systems, etc.

Utility devices are positioned within utility boxes fastened to the infrastructure. In the context of this discussion, utility box includes the typical box mounted to the premises structure into which a device, such as a switch, is mounted. Utility box, however, also includes devices that mount to (“tacked” onto) the surface of the structure, such as, for example, a thermostat. In a typical environment, the utility device is connected to infrastructure wiring. However, many other types of devices can also be mounted in a utility box framework. Some of these devices can include portions or “elements” that wear-out or otherwise become inaccurate or inoperable sooner than other parts of the device and therefore need to be renewed separately from the device from time to time. Other renewable elements are those that may not suffer from wear or inaccuracy over time but that could or should be replaced or renewed as technology improves and costs become affordable. An example of an element that must be renewed or replaced from time to time (herein called a renewable element) is a CO monitor. Other renewable elements can include, for example, those that monitor or sense (or offer improved monitoring and sensing of): CO2, biohazards, fire, video, audio, messages, alerts, alarms, medical condition, data types, access, remote controls (e.g., for TVs, radios, lighting), media, identification, humidity, barometric pressure, weight (mass), motion, traffic patterns, power quality, operating costs, power factor, voltage, frequency, current, phasors, phase angle, impedance, active power, reactive power, energy storage, battery condition, priority, inertia, selective audio (audio recognition, e.g., voice, glass break), selective video (visual recognition, e.g., terrorist), flooding, vibration, smoke, radiation, ultrasound, acoustic sound, infrasound, infrared, microwave, electromagnetic radiation, nuclear radiation, coherent radiation, bacteria, bio-hazards, diseases, poisons, germs, toxic materials, air quality, weight, mass, load, stress, materials, etc.

One problem when renewable elements are used in a utility framework is that the devices that use them must be changed from time to time. Devices with a larger number of renewable elements, especially those with elements of different lifespans, must be changed much more often to deliver their intended service benefit. This then requires disconnecting the electrical connections from the infrastructure wiring, removing the device and then re-wiring the new device. Even in situations where the device can be easily removed from the electrical connections it is still required to remove the device and replace the device with a new or refurbished device when it is time to renew the device. This, at best, is a waste of resources.

### BRIEF SUMMARY OF THE INVENTION

The present invention is directed to a system and method which allows a user to renew a utility device by changing only the module (element) that needs to be renewed as opposed to replacing the entire device. In one embodiment the device is constructed in modular format such that the user need only replace the module portion of the device that has expired (or been used) instead of being required to replace the entire device. In another embodiment, the device is constructed in a modular format so that new modules (elements) can be added (as technology and costs improve) and/or so that the user need only add or replace the desired module instead of being required to replace the entire device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an infrastructure utility device in accordance with one aspect of the invention;

FIG. 2A shows an expanded view of the utility device illustrated in FIG. 1;

FIG. 2B shows the removal of a replaceable element in accordance with one embodiment; and

FIG. 3 shows a rear view of the replaceable element illustrated in FIG. 2B.

### DETAILED DESCRIPTION OF THE INVENTION

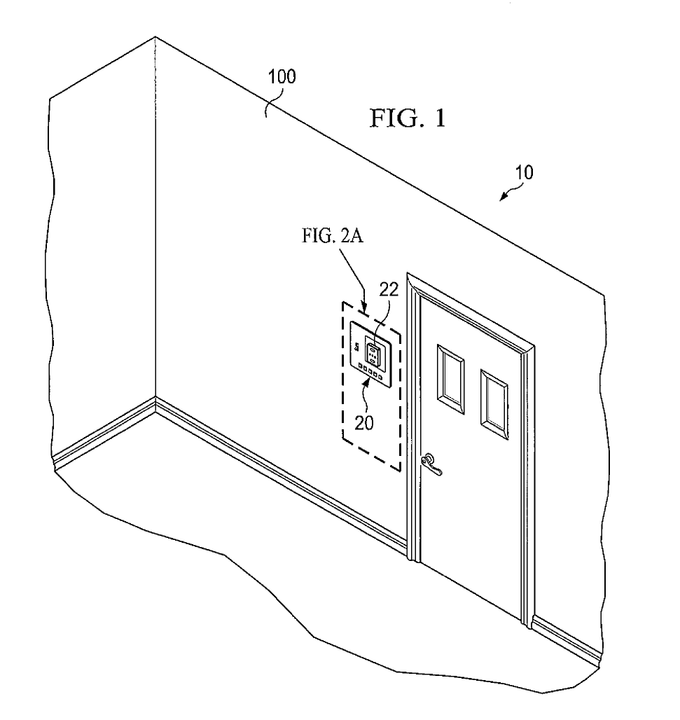

FIG. 1 shows infrastructure utility device 20 in accordance with one aspect of the invention. Device 20 is shown attached to the infrastructure wiring of premises 10. Typically, device 20 would be mounted permanently to a utility box, which in turn has premises wiring permanently terminated therein. In some situations, device 20 can be removed for remote operation as discussed in the above-identified patent application entitled “INFRASTRUCTURE DEVICE WITH REMOVABLE FACE PLATE FOR REMOTE OPERATION.” Device 20 can be a single function device, or a multiple function device as is shown with sub-devices 23 and 24, each performing separate functions. In the preferred embodiment, the connection to the infrastructure is within a utility device, but other devices, such as thermostats, intercoms, door bells, smoke alarms, audio and video panels, some cable outlets, phone jacks, etc., can be “tacked” into the premises wiring and, as discussed above, are considered to be within utility boxes.

In the embodiment of FIG. 1, device 20 has sub-device 21 contained therewith. Device 21 is a device, such as a CO2 detector, that must be changed, or cleaned, from time to time. Device 21 can be any type of device, such as is used for control, sensing, measuring, verification, etc. Instead of requiring that device 21 be removed and exchanged in total, device 21 has been designed with at least one renewable element, such as element 22, which is a self-contained portion of device 21. Element 22 can be removed from device 21 and renewed. Such renewing can be accomplished by cleaning and/or replacement. The renewing could be with an element that has been technically updated, if desired. In some situations, the renewed element can add or change functions.

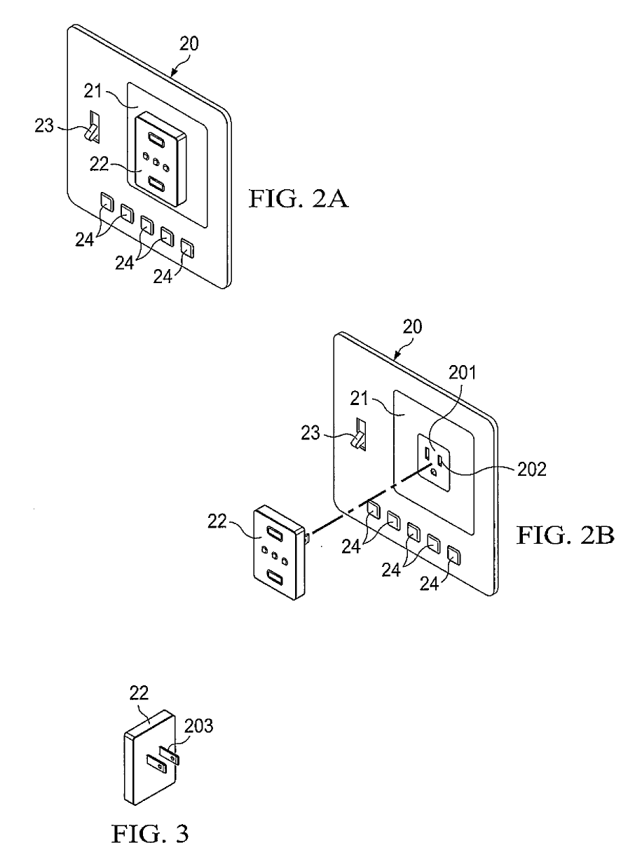

FIG. 2A shows an expanded view of device 21 with one renewable element 22. FIG. 2B shows the removal of the replaceable element in accordance with one embodiment. Note that device 22 is shown electrically connectable to device 21 by plug pair 202/203. As shown, device 22 fits into socket 201. In some situations, when element 22 is renewed, a sensor, such as sensor 25, can defect the removal and sound an alarm or send a signal depending upon the situation. It should be noted that the interface socket can have any number of connections.

FIG. 3 shows a rear view of replaceable element 22. Note that the electrical connection between the renewable element and the main device can be by physical connection, as shown, or by wireless connection. As noted above, the physical connection type can be any arrangement desired that allows the renewable element to electrically communicate with the utility device.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A utility device comprising:
a first portion for electrically connecting to premises infrastructure wiring;
a second portion for mating with said first portion, said second portion requiring renewing from time to time; and
a removable module for housing said second portion, said module adapted for electrical connection to said first portion.

2. The utility device of claim 1 wherein said module is removable from said first portion without requiring the removal of said first portion from said box.

3. The utility device of claim 2 wherein said second portion is selected from the list of detectors, monitors, and sensors: CO; CO₂; biohazard; fire; video; audio; messages; alerts; alarms; medical condition; data type; access; remote control (e.g., for TVs, radios, lighting); media; identification; humidity; barometric pressure; weight (mass); traffic patterns; occupancy; motion; power quality; operating cost; power factor; voltage; frequency; current; phasor; phase angle; impedance; active power; reactive power; energy storage; battery condition; priority; proximity; inertia; selective audio frequency (audio recognition, e.g., voice, glass break); selective video (visual recognition, e.g., terrorist); flooding; vibration; smoke; radiation; ultrasound; acoustic sound; infrasound; infrared; light; microwave; radio frequency; electromagnetic radiation; nuclear radiation; coherent radiation; bacteria; bio-hazards; diseases; poisons; germs; toxic materials; air quality; load; stress; material type.

4. The utility device of claim 2 wherein said first portion comprises:
at least one device selected from the list of: electrical switch, electrical outlet socket, electric light; motion sensor, clock, temperature sensor, monitor, intercom, speaker, temperature control, humidistat, CO detector; CO₂ detector; biohazard detector; fire detector; video display; message panel; alert panel; alarm panel; medical monitor; data access panel; data access interface; physical access panel; physical access interface; multimedia interface; identification interface; barometric pressure monitor; weight (mass) monitor; traffic pattern monitor; occupancy monitor; motion monitor; power quality monitor; operating cost monitor; power factor monitor; voltage monitor; frequency monitor; current monitor; phasor monitor; phase angle monitor; impedance monitor; active power monitor; reactive power monitor; energy storage monitor; battery condition monitor; priority monitor; proximity monitor; inertia monitor; selective audio frequency monitor (audio recognition, e.g., voice, glass break); selective video monitor (visual recognition, e.g., terrorist); flooding monitor; vibration monitor; smoke monitor; radiation monitor; ultrasound monitor; acoustic sound monitor; infrasound monitor; infrared monitor; light monitor; microwave monitor; radio frequency monitor; electromagnetic radiation monitor; nuclear radiation monitor; coherent radiation monitor; bacteria monitor; bio-hazard monitor; disease monitor; poison monitor; germ monitor; toxic material monitor; air quality monitor; load monitor; stress monitor; material type monitor.

5. A renewable device for use in conjunction with premises infrastructure wiring, said device comprising:
means for electrically connecting said renewable device to said premises wiring, and
means for allowing a portion of said renewable device containing a renewable element to be substituted without separating said renewable device from said premises wiring.

6. The device of claim 5 wherein said second portion is selected from the list of detectors, monitors, and sensors: CO; CO₂; biohazard; fire; video; audio; messages; alerts; alarms; medical condition; data type; access; remote control (e.g., for TVs, radios, lighting); media; identification; humidity; barometric pressure; weight (mass); traffic patterns; occupancy; motion; power quality; operating cost; power factor; voltage; frequency; current; phasor; phase angle; impedance; active power; reactive power; energy storage; battery condition; priority; proximity; inertia; selective audio frequency (audio recognition, e.g., voice, glass break); selective video (visual recognition, e.g., terrorist); flooding; vibration; smoke; radiation; ultrasound; acoustic sound; infrasound; infrared; light; microwave; radio frequency; electromagnetic radiation; nuclear radiation; coherent radiation; bacteria; bio-hazards; diseases; poisons; germs; toxic materials; air quality; load; stress; material type.

7. The device of claim 5 further comprising:
at least one alternate renewable element operable for use when said renewable element is in need of being replaced.

8. The device of claim 7 further comprising:
a switch for substituting said alternate renewable element for said renewable element.

9. A utility device comprising:
at least one renewable device adapted for mounting within a utility box, said mounting being concurrently with at least one electrical control/monitoring device selected from the list of: electrical switch, electrical outlet socket, electric light; motion sensor, clock, temperature sensor, monitor, intercom, speaker, temperature control, humidistat, CO detector; CO₂ detector; biohazard detector; fire detector; video display; message panel; alert panel; alarm panel; medical monitor; data access panel; data access interface; physical access panel; physical access interface; multimedia interface; identification interface; barometric pressure monitor; weight (mass) monitor; traffic pattern monitor; occupancy monitor; motion monitor; power quality monitor; operating cost monitor; power factor monitor; voltage monitor; frequency monitor; current monitor; phasor monitor; phase angle monitor; impedance monitor; active power monitor; reactive power monitor; energy storage monitor; battery condition monitor; priority monitor; proximity monitor; inertia monitor; selective audio frequency monitor (audio recognition, e.g., voice, glass break); selective video monitor (visual recognition, e.g., terrorist); flooding monitor; vibration monitor; smoke monitor; radiation monitor; ultrasound monitor; acoustic sound monitor; infrasound monitor; infrared monitor; light monitor; microwave monitor; radio frequency monitor; electromagnetic radiation monitor; nuclear radiation monitor; coherent radiation monitor; bacteria monitor; bio-hazard monitor; disease monitor; poison monitor; germ monitor; toxic material monitor; air quality monitor; load monitor; stress monitor; material type monitor, said electrical device(s) adapted for becoming electrically connected to premises electrical wiring within said utility box and
means for allowing a portion of said renewable device containing a renewable element to be removed from said utility box separate from a removal of any device concurrently mounted in said utility box.

10. The utility device of claim 9 further comprising:
means for allowing said renewable device(s) to become electrically connected to said premises wiring within said utility box.

11. The utility device of claim 9 further comprising:
means for allowing said renewable device(s) to become electrically connected to at one of said electrical control devices.

12. The utility device of claim 5 further comprising:
at least one alternate renewable element operable for use when said renewable element is in need of being updated.

13. The utility device of claim 7 further comprising:
means for substituting said alternate renewable element for said renewable element.

14. A utility device comprising:
an electrical control device selected from the list of: electrical switch, electrical outlet socket, electric light; motion sensor, clock, temperature sensor, monitor, intercom, speaker, temperature control, humidistat, CO detector; CO₂ detector; biohazard detector; fire detector; video display; message panel; alert panel; alarm panel; medical monitor; data access panel; data access interface; physical access panel; physical access interface; multimedia interface; identification interface; barometric pressure monitor; weight (mass) monitor; traffic pattern monitor; occupancy monitor; motion monitor; power quality monitor; operating cost monitor; power factor monitor; voltage monitor; frequency monitor; current monitor; phasor monitor; phase angle monitor; impedance monitor; active power monitor; reactive power monitor; energy storage monitor; battery condition monitor; priority monitor; proximity monitor; inertia monitor; selective audio frequency monitor (audio recognition, e.g., voice, glass break); selective video monitor (visual recognition, e.g., terrorist); flooding monitor; vibration monitor; smoke monitor; radiation monitor; ultrasound monitor; acoustic sound monitor; infrasound monitor; infrared monitor; light monitor; microwave monitor; radio frequency monitor; electromagnetic radiation monitor; nuclear radiation monitor; coherent radiation monitor; bacteria monitor; bio-hazard monitor; disease monitor; poison monitor; germ monitor; toxic material monitor; air quality monitor; load monitor; stress monitor; material type monitor, said electrical device(s) adapted for becoming electrically connected to premises electrical wiring within a premises utility box;
a renewable device mounted in conjunction with said control/monitoring devices, and
means for allowing a portion of said renewable device containing a renewable element to be substituted without separating said renewable device from said electrical device.

15. The utility device of claim 14 further comprising:
means for allowing each said renewable device to become electrically connected to said premises wiring within said utility box.

16. The utility device of claim 14 further comprising:
means for allowing each said renewable device to become electrically connected to at least one of said electrical devices.

17. The utility device of claim 14 further comprising:
at least one alternate renewable element operable for use when said renewable element is in need of being replaced.

18. The utility device of claim 17 further comprising:
a switch for substituting said alternate renewable element for said renewable element.

19. A method for changing a renewable element in a utility device; said method comprising:
removing said renewable element from said utility device without disconnecting said utility device from a utility box to which said utility device is mounted; and
replacing a removed renewable element with a renewed element without disconnecting said utility device from said utility box.

20. The method of claim 19 further comprising:
providing a signal when said renewable element is in need of being replaced.

21. The method of claim 19 further comprising:
switching to an alternate element without user intervention when a renewable element is in need of replacement.

22. The method of claim 19 further comprising:
providing a signal when said renewable element is removed.

23. The method of claim 19 further comprising:
providing a signal when said renewable element is replaced.

24. A device for use in a utility box, said device comprising:
means for electrically connecting said device to premises wiring within said utility device, and
means for allowing a portion of a connected device to be renewed without separating said connected device from said premises wiring.

25. The utility device of claim 24 wherein said additional portion is selected from the list of detectors, monitors, and sensors: CO; CO₂; biohazard; fire; video; audio; messages; alerts; alarms; medical condition; data type; access; remote control (e.g., for TVs, radios, lighting); media; identification; humidity; barometric pressure; weight (mass); traffic patterns; occupancy; motion; power quality; operating cost; power factor; voltage; frequency; current; phasor; phase angle; impedance; active power; reactive power; energy storage; battery condition; priority; proximity; inertia; selective audio frequency (audio recognition, e.g., voice, glass break); selective video (visual recognition, e.g., terrorist); flooding; vibration; smoke; radiation; ultrasound; acoustic sound; infrasound; infrared; light; microwave; radio frequency; electromagnetic radiation; nuclear radiation; coherent radiation; bacteria; bio-hazards; diseases; poisons; germs; toxic materials; air quality; load; stress; material type.

26. The utility device of claim 24 further comprising:
at least one alternate element operable for use when said additional element is in need of being replaced.

27. The utility device of claim 24 further comprising:
a switch for substituting said alternate additional element for said additional element.

28. A renewable element for use with a permanently mounted utility device, said element comprising:
control functions necessary for allowing said permanently mounted utility device to function properly; and
a connector for allowing said renewable element to electrically communicate with said permanently mounted device.

29. The device of claim 28 further comprising:
means for providing a signal when said addition portion is added.
